(19) United States
(12) Patent Application Publication
(10) Pub. No.: US 2014/0184112 A1
(43) Pub. Date: Jul. 3, 2014

(54) METHOD AND APPARATUS OF CONTROLLING DRIVING OF TWO-PHASE SWITCHED RELUCTANCE MOTOR

(71) Applicant: SAMSUNG ELECTRO-MECHANICS CO., LTD., Suwon (KR)

(72) Inventors: Hyung Joon Kim, Suwon (KR); Guen Hong Lee, Suwon (KR); Joung Ho Son, Suwon (KR); Han Kyung Bae, Suwon (KR); Hong Chul Shin, Suwon (KR)

(73) Assignee: Samsung Electro-Mechanics Co., Ltd., Suwon (KR)

(21) Appl. No.: 13/845,055

(22) Filed: Mar. 17, 2013

(30) Foreign Application Priority Data
Dec. 28, 2012 (KR) 10-2012-0157154

(51) Int. Cl. H02P 25/08

(52) U.S. Cl. CPC H02P 25/082
USPC 318/254.1

(57) ABSTRACT

Disclosed herein are a method and apparatus of controlling driving of a two-phase switched reluctance motor (SRM). The apparatus includes: a target speed arrival judging unit judging whether or not a current speed of the SRM has arrived at a target speed; a zero volt switching (ZVS) achievement judging unit judging whether or not the SRM is in a state in which ZVS is possible; a negative torque generation judging unit judging whether or not a negative torque has been generated in the SRM; an advanced angle controlling unit judging whether or not an advanced angle will be controlled based on judgment results of the target speed arrival judging unit, the ZVS achievement judging unit, and the negative torque generation judging unit; and a dwell angle controlling unit judging whether or not a dwell angle will be controlled on the judgment results.

### CROSS REFERENCE TO RELATED APPLICATION

This application claims the benefit of Korean Patent Application No. 10-2012-0157154, filed on Dec. 28, 2012, entitled “The Method of Controlling Motion of 2 Phase Switch Relectance Motor and Apparatus Using the Same”, which is hereby incorporated by reference in its entirety into this application.

### BACKGROUND OF THE INVENTION

1. Technical Field

The present invention relates to a method and apparatus of controlling driving of a two-phase switched reluctance motor (SRM).

2. Description of the Related Art

A switched reluctance motor (SRM) is one of the old motors that have been used over 150 years. This traditional type of reluctance motor has been known as the switched reluctance motor in order to satisfy a condition of a variable drive in accordance with the development of a power semiconductor. ‘Switched Reluctance’ was named by S. A. Nasar and has described two main features of the SRM. First, ‘Switched’ means that a motor should always be operated in a continuous switching mode. This term has been used after applying a new type of power semiconductor in accordance with development and advance of the new type of power semiconductor. Second, ‘Reluctance’ means a double salient pole type structure in which a rotor and a stator are operated by varying a reluctance magnetic circuit.

Scholars such as Nasar, French, Koch, and Lawrenson have devised a continuous mode control using a power semiconductor unlike a structurally similar stepping motor, in the 1960s. At that time, since only a power thyristor semiconductor has a function of controlling a relatively high voltage and current, it has been used to control the switched reluctance motor. At the present time, a power transistor, a gate turn-off thyristor (GTO), an insulated gate bipolar mode transistor IGBT, a power metal oxide semiconductor field effect transistor (MOSFET), and the like, have been developed and variously used in a rated power range for controlling the SRM.

The SRM has a very simple structure. The SRM does not include a permanent magnet, a brush, and a commutator. In this SRM, a stator includes salient poles and has a structure in which steels are stacked, and winding around which coils connected in series with each other are wound are independently connected to the respective phases and enclose stator poles. A rotor does not include a winding, has a structure in which steels are stacked, and includes salient poles, similar to the stator. Therefore, since both of the stator and the rotor have the salient pole structure, the SRM may be considered as having a double salient pole type structure. Due to this simple structure, reliability is increased and a production cost is decreased, such that it is likely that the SRM will substitute for a variable speed drive.

In the case in which the SRM as described above is used in home appliances such as a clearer, or the like, high speed driving is required. In this case, large noise or vibration is generated due to the high speed driving. Therefore, a solution to this problem has been demanded.

### PRIOR ART DOCUMENT

### Patent Document

(Patent Document 1) KR2002-0003781

### SUMMARY OF THE INVENTION

The present invention has been made in an effort to provide an apparatus of controlling driving of a switched reluctance motor (SRM) capable of decreasing noise or vibration.

Further, the present invention has been made in an effort to provide a method of controlling driving of an SRM capable of decreasing noise or vibration.

According to a preferred embodiment of the present invention, there is provided an apparatus of controlling driving of a switched reluctance motor (SRM), the apparatus including: a target speed arrival judging unit judging whether or not a current speed of the SRM has arrived at a target speed; a zero volt switching (ZVS) achievement judging unit judging whether or not the SRM is in a state in which ZVS is possible; a negative torque generation judging unit judging whether or not a negative torque has been generated in the SRM; an advanced angle controlling unit judging whether or not an advanced angle will be controlled based on judgment results of the target speed arrival judging unit, the ZVS achievement judging unit, and the negative torque generation judging unit; and a dwell angle controlling unit judging whether or not a dwell angle will be controlled based on the judgment results of the target speed arrival judging unit, the ZVS achievement judging unit, and the negative torque generation judging unit.

The target speed arrival judging unit may be implemented to change the advanced angle in the advanced angle controlling unit and change the dwell angle in the dwell angle controlling unit in the case in which it judges that the current speed of the SRM has not arrived at the target speed.

The target speed arrival judging unit may be implemented to decrease the advanced angle and the dwell angle in the case in which it judges that the current speed of the SRM is more than the target speed and increase the advanced angle and the dwell angle in the case in which it judges that the current speed of the SRM is less than the target speed.

The ZVS achievement judging unit may be implemented to decrease the advanced angle in the advanced angle controlling unit and increase the dwell angle in the dwell angle controlling unit in the case in which it judges that the SRM is in a state in which the ZVS is not possible.

The ZVS achievement judging unit may be implemented to judge that the SRM is in a state in which the ZVS is possible in the case in which a current input to a converter of the SRM is sensed, such that a current having a negative polarity is present.

The negative torque generation judging unit may be implemented to judge whether or not the negative torque has been generated in the SRM and increase the advanced angle in the advanced angle controlling unit and decrease the dwell angle in the dwell angle controlling unit in the case in which it judges that the negative torque has been generated in the SRM.

The negative torque generation judging unit may be implemented to judge that the negative torque has been generated when a current of a diode is sensed, such that a flow of a current is present at phases of 0 degree and 180 degrees.

According to another preferred embodiment of the present invention, there is provided a method of controlling driving of an SRM, the method including: normally driving the SRM after an initial driving section of the SRM; and controlling a dwell angle and an advanced angle of the SRM by performing an operation control mode of the SRM.

The controlling of the dwell angle and the advanced angle of the SRM by performing the operation control mode of the SRM may include: judging whether or not a current speed of the SRM has arrived at a target speed; driving the SRM at the target speed by controlling the dwell angle and the advanced angle in the case in which it is judged that the current speed of the SRM has not arrived at the target speed; and judging whether or not the SRM is in a state in which ZVS is possible in which it is judged that the current speed of the SRM has arrived at the target speed.

The driving of the SRM at the target speed by controlling the dwell angle and the advanced angle in the case in which it is judged that the current speed of the SRM has not arrived at the target speed may include: decreasing the advanced angle and the dwell angle in the case in which it is judged that the current speed of the SRM is more than the target speed; and increasing the advanced angle and the dwell angle in the case in which it is judged that the current speed of the SRM is less than the target speed.

The controlling of the dwell angle and the advanced angle of the SRM by performing the operation control mode of the SRM may include: judging whether or not the SRM is in the state in which the ZVS is possible; and controlling the SRM to be in the state in which the ZVS is possible by decreasing the advanced angle and increasing the dwell angle in the case in which it is judged that the SRM is in a state in which the ZVS is not possible.

The judging of whether or not the SRM is in the state in which the ZVS is possible may include judging that the SRM is in the state in which the ZVS is possible in the case in which a current input to a converter of the SRM is sensed, such that a current having a negative polarity is present.

The controlling of the dwell angle and the advanced angle of the SRM by performing the operation control mode of the SRM may include: judging whether or not a negative torque has been generated in the SRM; and increasing the advanced angle and decreasing the dwell angle in the case in which it is judged that the negative torque has been generated in the SRM.

The judging of whether or not the negative torque has been generated in the SRM may include judging that the negative torque has been generated when a current of a diode is sensed, such that a flow of a current is present at phases of 0 degree and 180 degrees.

The normal driving of the SRM after the initial driving section of the SRM may include: allowing power to flow in a winding of the SRM to move a stator and a rotor to a determined position, thereby setting the SRM to be in a standby state; changing an initial set dwell angle of the SRM into a dwell angle in a normal operation state and raising a pulse width modulation (PWM) frequency; and changing an initial set advanced angle of the SRM into an advanced angle in the normal operation state and raising the PWM frequency.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of a switching apparatus of a two-phase switched reluctance motor (SRM) according to a preferred embodiment of the present invention;

FIG. 2 is a detailed configuration diagram of a zero voltage switching converter of FIG. 1;

FIG. 3 is a graph showing a method of controlling an operation of the SRM according to the preferred embodiment of the present invention for each section;

FIGS. 4A to 5F are conceptual diagrams showing an operation of the zero voltage switching converter according to the preferred embodiment of the present invention;

FIG. 6 is a flow chart showing a method of driving the SRM according to the preferred embodiment of the present invention; and

FIG. 7 is a flow chart showing an apparatus of controlling driving of the SRM according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

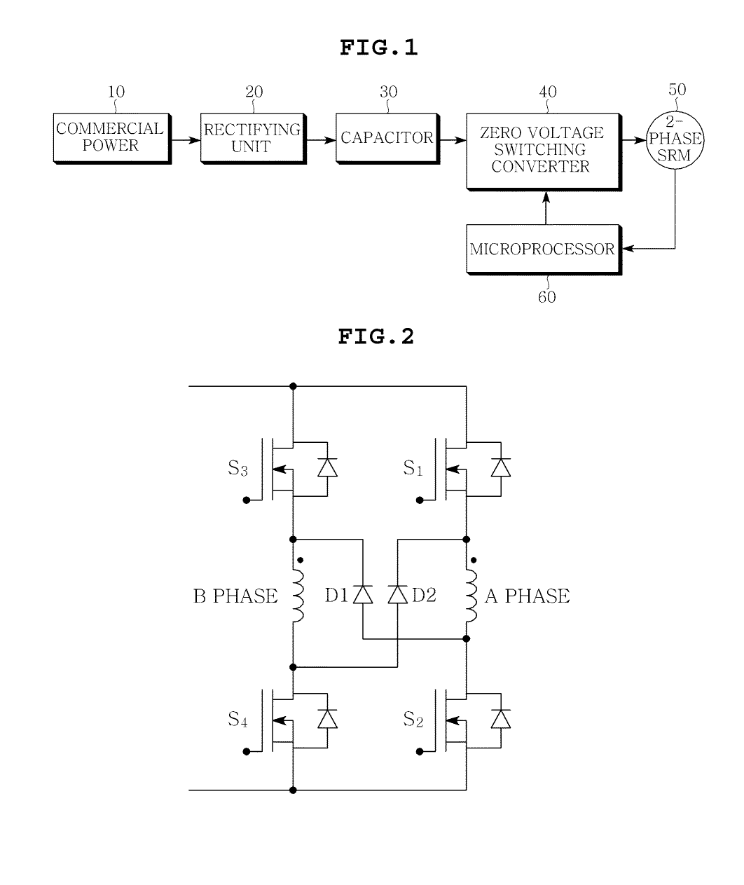

FIG. 1 is a configuration diagram of a switching apparatus of a two-phase switched reluctance motor (SRM) according to a preferred embodiment of the present invention.

Referring to FIG. 1, the switching apparatus of a two-phase switched reluctance motor is configured to include a rectifying unit 20 rectifying commercial power 10 to supply direct current (DC) power, a capacitor 30 connected to the rectifying unit 20, a zero voltage switching converter 40 connected to the capacitor 30, and a microprocessor 60 sensing a position and a speed of a two-phase SRM 50 and controlling the zero voltage switching converter 40.

The rectifying unit 20 rectifies the input commercial power 10 to supply the DC power to the capacitor 30. The capacitor 30 may improve a power factor of the rectified DC power, absorb noise, and supply the DC voltage of which the power factor is improved and the noise is absorbed to the zero voltage switching converter 40.

The zero voltage switching converter 40 may include a pair of upper and lower switches connected in series with upper and lower portions of each of the two phase windings of the two-phase SRM 50 and a pair of diodes cross-connected to both ends of the two phase windings, and be operated in operation modes 1 to 3 according to a control of the microprocessor 60 to drive the two-phase SRM 50.

Meanwhile, the microprocessor 60 may sense the position and the speed of the two-phase SRM 50 and control the pair of upper and lower switches of the zero voltage switching converter 40 to allow the switches to be operated in operation modes 1 to 3, thereby driving the two-phase SRM 50.

Here, in operation mode 1, positive DC voltage is applied to a corresponding phase winding of the two-phase SRM 50 to increase current in the winding, in operation mode 2, the current is allowed to be circulated in the winding when it flows in the winding, such that it is slowly decreased, and in operation mode 3, negative DC voltage is applied to a corresponding phase winding to rapidly decrease the current.

The switching apparatus of a two-phase switched reluctance motor configured as described above is operated as follows.

First, the microprocessor 60 controls the zero voltage switching converter 40 so as to be operated in operation modes 1 to 3 to excite any one of the two phase windings of the two-phase SRM 50 and then finish a state in which the phase winding is excited.

Then, the microprocessor 60 controls the zero voltage switching converter 40 so as to be operated in operation modes 1 to 3 to excite the other of the two phase windings of the two-phase SRM 50 and then finish a state in which the other winding is excited.

Next, the microprocessor 60 repeatedly performs the above-mentioned operation to drive the two phase SRM 50.

In this case, the microprocessor 60 may control the zero voltage switching converter 40 in various schemes so as to be operated in operation modes 1 to 3.

FIG. 2 is a detailed configuration diagram of a zero voltage switching converter according to the preferred embodiment of the present invention.

Referring to FIG. 2, the zero voltage switching converter of FIG. 1 may include a first upper switch S₁ connected in series with an upper portion of an A phase winding, a first lower switch S₂ connected in series with a lower portion of the A phase winding, a second upper switch S₃ connected in series with an upper portion of a B phase winding, and a second lower switch S₄ connected in series with a lower portion of the B phase winding.

In addition, the zero voltage switching converter 40 includes a first diode D1 having an anode connected to a contact between the A phase winding and the first lower switch S₂ and a cathode connected to a contact between the B phase winding and the second upper switch S₃ and a second diode D2 having an anode connected to a contact between the B phase winding and the second lower switch S₄ and a cathode connected to a contact between the A phase winding and the first upper switch S₁.

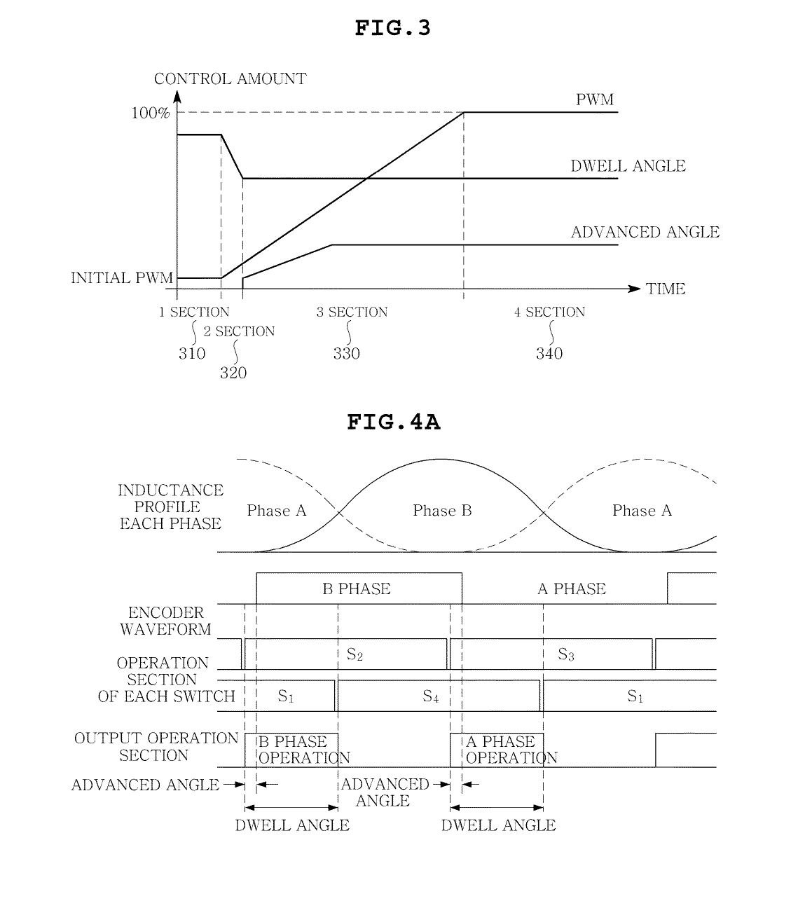

In the zero voltage switching converter 40 as described above, the first upper switch S₁ and the second lower switch S₄ are turned on in each half period while having a phase difference of 180 degrees therebetween as shown in FIG. 3. In addition, the first lower switch S₂ and the second upper switch S₃ are also turned on in each half period while having a phase difference of 180 degrees therebetween as shown in FIG. 3.

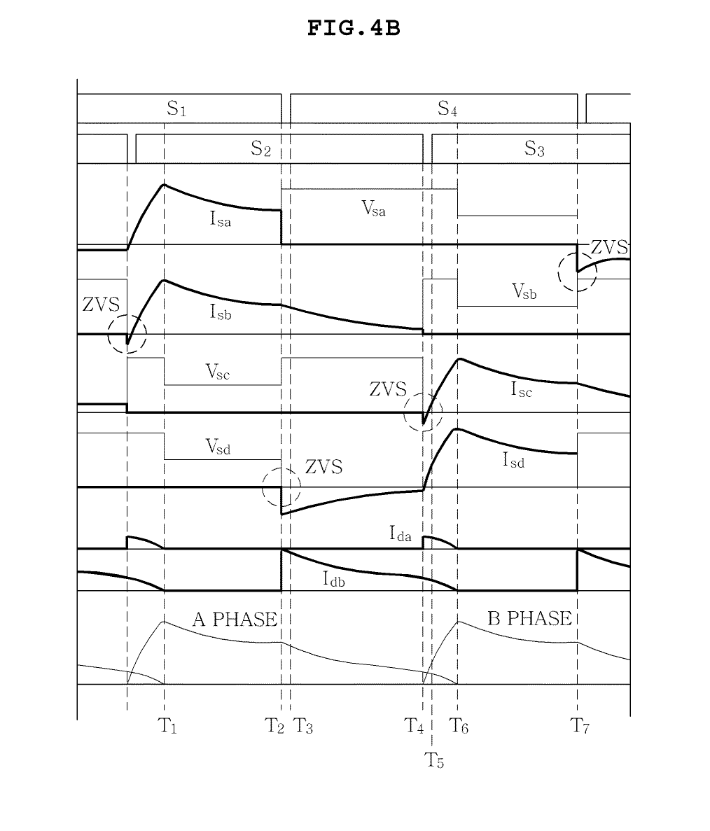

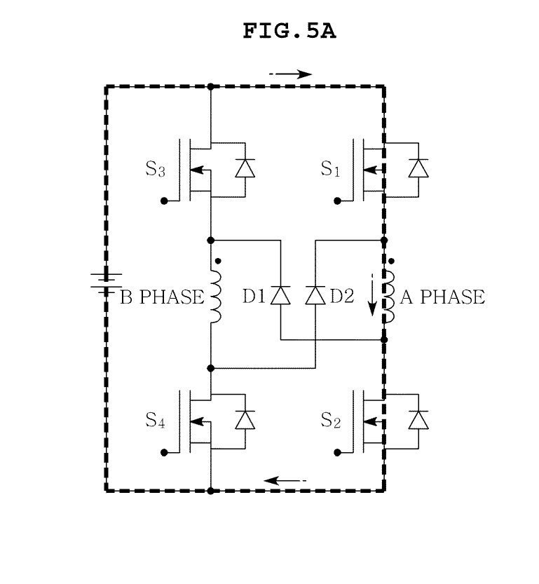

The zero voltage switching converter 40 as described above may adjust the first lower switch S₂ and the second upper switch S₃ based on an encoder waveform to control an advanced angle and adjust the first upper switch S₁ and the second lower switch S₄ based on the encoder waveform to control a dwell angle, as shown in FIG. 4A.

The first upper switch S₁ may adjust a dwell angle of the A phase of the SRM. The first upper switch S₁ may be operated depending on the second lower switch S₄ and have a phase difference of 180 degrees from the second lower switch S₄.

The first lower switch S₂ may adjust an advanced angle of the B phase of the SRM. A central processing unit (CPU) of a controller understands and judges information read by a sensor to adjust a point in time at which the first lower switch S₂ is turned on according to a speed state and a zero voltage switching (ZVS) state of the SRM, thereby making it possible to control the advanced angle. A process in which the CPU of the controller understands and judges the information read by the sensor to adjust the point in time at which the first lower switch S₂ is turned on according to the speed state and the ZVS state of the SRM, thereby making it possible to control the advanced angle will be further described in detail.

The second upper switch S₃ may adjust an advanced angle of the A phase of the SRM. The second upper switch S₃ may be operated depending on the first lower switch S₂ and have a phase difference of 180 degrees from the first lower switch S₂.

The second lower switch S₄ may adjust a dwell angle of the B phase of the SRM. The second lower switch S₄ adjusts a point in time at which it is turned on according to the speed state and the ZVS state of the SRM, thereby making it possible to control the dwell angle, similar to the above-mentioned first lower switch. A difference between points in time at which the first lower switch S₂ and the second lower switch S₄ may correspond to the dwell angle.

According to the preferred embodiment of the present invention, the driving of the SRM may be controlled by changing an advanced angle, a dwell angle, and a pulse width modulation (PWM) duty ratio. In the case in which the dwell angle, the advanced angle, and the PWM duty ratio are changed, the following changes may occur in the driving of the SRM.

1) The dwell angle (θ_{DW}) indicates a difference between a turn-off angle and a turn-on angle when it is assumed that a position of a rotor at which a stator current is switched on is the turn-on angle and a position of the rotor at which the stator current is switched off in the SRM is the turn-off angle, as described above.

An advanced angle (θ_{AD}) indicates a section in which power is applied to the winding to excite the winding. In the case in which the advanced angle is changed, a turn-on point in time is shifted ahead, such that a current rising time is changed. The dwell angle and the advanced angle are changed, thereby making it possible to adjust a revolution per minute (RPM) of the SRM. For example, the lead angle is adjusted to shift the turn-on point in time ahead, thereby making it possible to make a current rising time sufficient, and the dwell angle is adjusted to use a torque generation region as much as possible but minimize a magnitude of the current before a section in which the negative torque is generated is reached, thereby making it possible to suppress the generation of the negative torque. That is, in the case in which the dwell angle is adjusted, the torque generation region may be used as much as possible, but the magnitude of the current may be minimized before the section in which the negative torque is generated is reached.

In addition, since torque characteristics of the SRM is unrelated to a direction of the current and has the same sign as that of a gradient of the inductance, it is impossible to rotate the SRM in a reverse direction by controlling only the current. Therefore, in order to rotate the SRM in a forward or reverse direction, it is required to control the angle to allow the current to flow in a section in which a torque is generated in a desired rotation direction. In addition, the angle control may also be used at the time of sudden braking.

That is, in the case in which the dwell angle is changed, the section in which the torque is generated is changed in the SRM, thereby making it possible to control the variation of the load of the SRM.

2) In the case of changing the PWM duty ratio, the current flowing in the SRM is controlled, thereby making it possible to control the variation of the load of the SRM. A method of changing the PWM duty ratio to control the variation of the load of the SRM may be mainly used to control the SRM driven at a low speed or a medium speed.

In the case of the SRM driven at the low speed or the medium speed, since back electromotive force and an increase in the inductance of the SRM are slowly generated, a rising ratio of the current by an applied voltage is large, such that a peak current may be larger than a peak current of the SRM driven at a high speed. In order to limit this current to be smaller than a current of a switching apparatus, the switching apparatus is turned on or turned off by chopping, thereby making it possible to control the SRM at a desired speed.

FIG. 3 is a graph showing a method of controlling an operation of the SRM according to the preferred embodiment of the present invention for each section.

Referring to FIG. 3, a first section 310 indicates a state before a turn-on signal is input to a controlling unit of a motor and indicates a state in which only alternating current (AC) power is input to the controlling unit. In this section, only a small amount of power is allowed to flow a winding of the SRM to move the stator and the rotor of the SRM to a determined position, such that the SRM is set to be in a driving standby state. When a current flows in the phase of the stator, a torque that is to rotate the rotor in a direction in which an inductance increases until the rotor arrives at a position at which it has a maximum inductance value is generated. When a magnetization component does not remain in an iron core, a direction of the current is unrelated to a polarity of the torque, which is always generated in a direction in which the rotor is to move to an alignment position that is the closest thereto. The dwell angle may be set to an initial set dwell angle.

A second section 320 indicates a state in which the turn-on signal is input to the controlling unit of the motor, such that the motor starts to be driven. In the second section 320, the dwell angle of the SRM is changed from the initial set dwell angle to a dwell angle set in a normal operation state. In this case, a PWM frequency for initial driving of the motor may rise. That is, in the case of changing the PWM duty ratio, the current flowing in the SRM is controlled, thereby making it possible to control a variation of a load of the SRM.

In a third section 330, a control for an advanced angle may be performed. As described above, in the case in which the advanced angle is changed, a turn-on point in time is shifted ahead, such that a current rising time is changed. That is, in the third section 330, the advanced angle is changed, thereby making it possible to adjust an RPM of the SRM.

A fourth section 340 indicates a section in which the PWM frequency maximally rises, such that the SRM is driven at a maximum duty ratio. In the fourth section 340, the SRM may be driven at a normal speed.

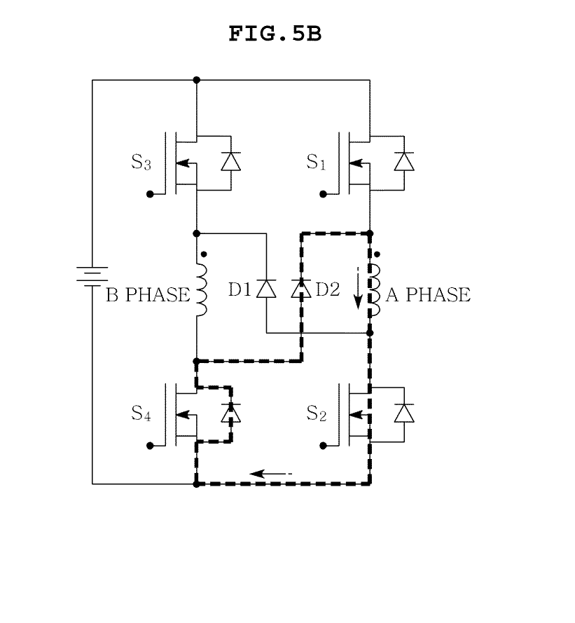

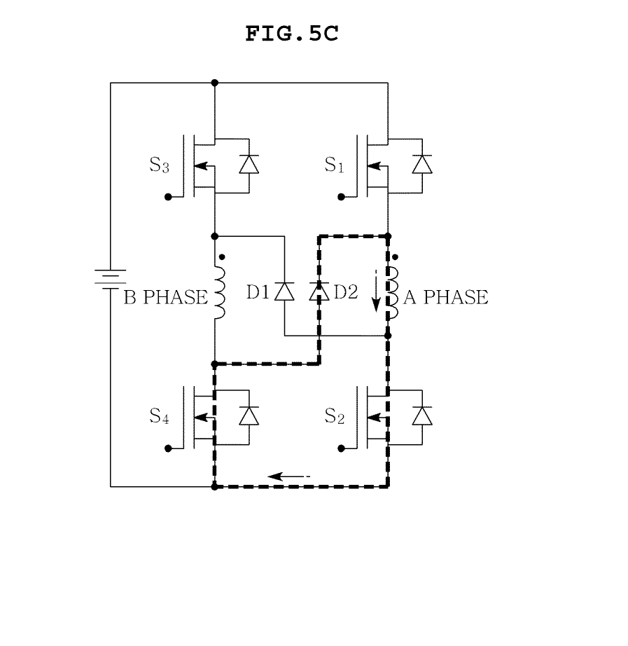

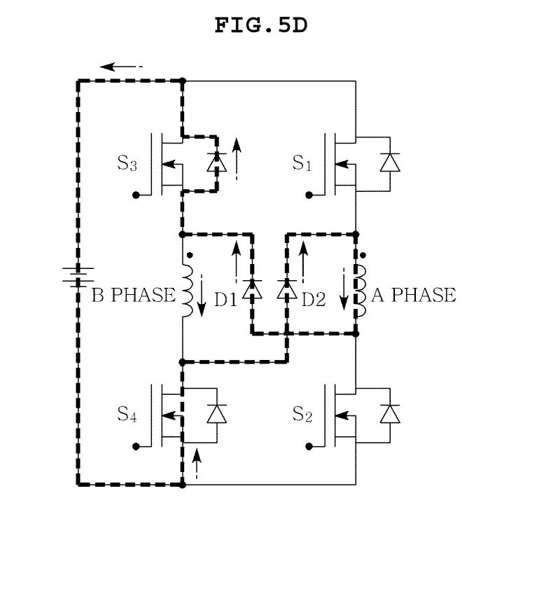

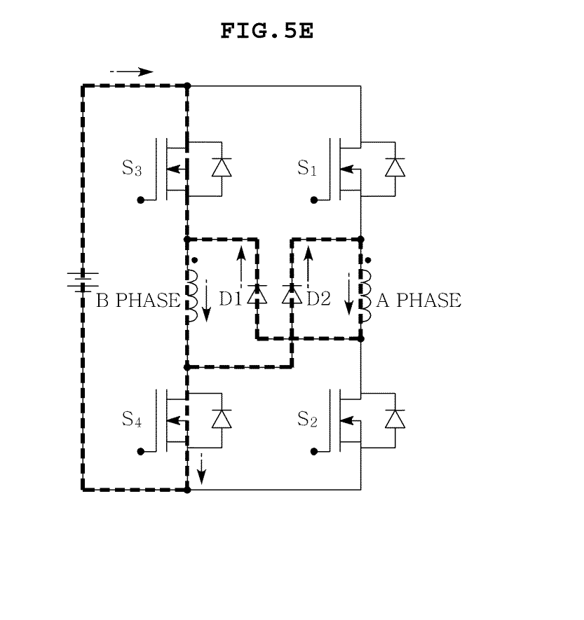

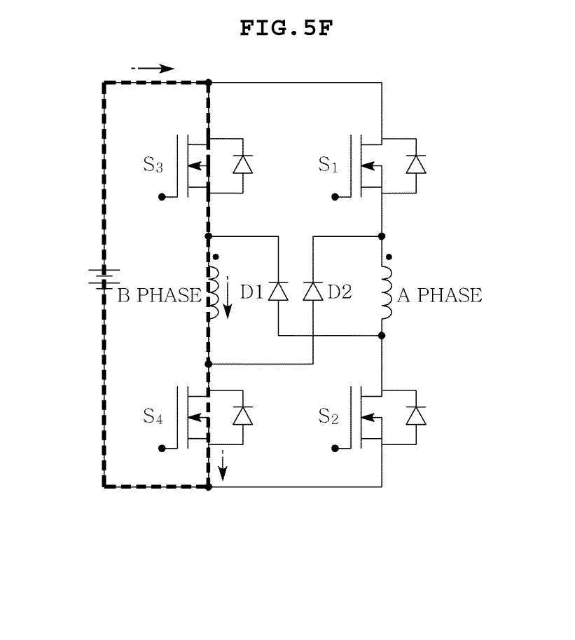

Hereinafter, an operation of the zero voltage switching converter according to the preferred embodiment of the present invention in the case in which the SRM is driven will be described with reference to FIGS. 4A to 5F.

FIGS. 4A to 5F are conceptual diagrams showing an operation of the zero voltage switching converter according to the preferred embodiment of the present invention.

The operation of the zero voltage switching converter 40 will be described in detail.

Referring to FIG. 4A, the first upper switch S₁ and the first lower switch S₂ are turned on. In this case, as shown in FIG. 5A, a current loop configured of the first upper switch S₁, the A phase winding, and the first lower switch S₂ is formed (A phase operation mode 1).

As described above, when a predetermined time elapses after the first upper switch S₁ and the first lower switch S₂ are turned on, the zero voltage switching converter 40 enters a normal operation section T1 to T2, such that a current Isa by an applied voltage flows in the first upper switch S₁, as shown in FIG. 4B. Here, the current Isa flowing in the first upper switch S₁ is gradually decreased with the passage of time. In this case, a voltage Vsa of the first upper switch S₁ becomes 0 by turn-on of the first upper switch S₁.

Further, as described above, when a predetermined time elapses after the first upper switch S₁ and the first lower switch S₂ are turned on, the zero voltage switching converter 40 enters a normal operation section T1 to T2, such that a current Isb by application of a DC voltage flows in the first lower switch S₂, as shown in FIG. 4B. Here, the current Isb flowing in the first lower switch S₂ is gradually decreased with the passage of time. In this case, a voltage Vsb of the first lower switch S₂ becomes 0 by a turn-on state of the first lower switch S₂.

In the normal operation section T1 to T2, the current flowing in the first upper switch S₁ and the current flowing in the first lower switch S₂ are the same as each other.

Meanwhile, in the next section (section T2 to T3 of FIG. 4B), the first upper switch S₁ is turned off, and the first lower switch S₂ is maintained in a turn-on state. In this case, as shown in FIG. 5B, a current loop configured of the A phase winding, the first lower switch S₂, the second lower switch S₄, and the second diode D2 is formed (A phase operation mode 2).

In this case, since the first upper switch S₁ is turned off, a current does not flow in the first upper switch S₁, and a voltage Vsa across the first upper switch S₁ approaches the applied DC voltage.

Further, since the first lower switch S₂ is maintained in a turn-on state, the current is slowly decreased, and the voltage is 0 by the turn-on state, that is, is not changed.

However, when the first upper switch S₁ is turned off and a voltage is applied across the first upper switch, the current that has flowed in the A phase winding is circulated through an internal diode of the second lower switch S₄ and the second diode D2.

Therefore, a circulation current Isd of the A phase winding flows in the internal diode of the second lower switch S₄ in a state in which a voltage across the second lower switch S₄ is maintained as 0 as shown in FIG. 4B.

In addition, as shown in FIG. 5B, a current flowing in a current loop configured of the A phase winding, the first lower switch S₂, the second lower switch S₄, and the second diode D2 is slowly decreased.

In this case, a current Idb flowing in the second diode D2 is the same as the current flowing in the first lower switch S₂ as shown in FIG. 4B.

Next, in this state, the first lower switch S₂ is continuously maintained in a turn-on state, and the second lower switch S₄ is turned on (in a section T3 to T4 of FIG. 4B).

In this case, since the first lower switch S₂ is maintained in a turn-on state, the current is slowly decreased, and the voltage is 0 by the turn-on state, that is, is not changed.

At this time, the second lower switch S₄ is turned on, such that the current flowing in the A phase winding directly flows through the second lower switch S₄ rather than the internal diode of the second lower switch S₄ and the current that has flowed in the A phase winding through the second diode D2 is still circulated (maintain the A phase operation mode 2), as shown in FIG. 5C.

Therefore, a circulation current of the A phase winding flows in the second lower switch S₄ in a state in which a voltage across the second lower switch S₄ is maintained as 0 as shown in FIG. 4B.

In this case, a current flowing in a current loop configured of the A phase winding, the first lower switch S₂, the second lower switch S₄, and the second diode D2 is slowly decreased.

Further, in this case, the second lower switch S₄ is turned on a state of a zero voltage or less, thereby making it possible to minimize switching loss.

In addition, when the second lower switch S₄ is turned on the state of the zero voltage or less as described above, a current gradient is gradually decreased by speed electromotive force as represented by the following Equation 1.

$${V}_{dc} = {L}_{motor} \cdot \frac{d i}{d t} + i \cdot \frac{d {L}_{motor}}{d θ} \cdot ω \qquad ( Equation 1 )$$

Then, the first lower switch S₂ is turned off in a state in which the second lower switch S₄ is maintained (See a section T4 to T5 of FIG. 4B).

In this case, the first lower switch S₂ is turned off, such that a current loop configured of an internal diode of the second upper switch S₃, the first diode D1, the A phase winding, the second diode, and the second lower switch is formed, as shown in FIG. 5D.

In addition, the first lower switch S₂ is turned off, such that a current does not flow in the first lower switch S₂ and a voltage across the first lower switch S₂ approaches an input voltage due to the turn-off of the first lower switch S₂, as shown in FIG. 4B.

In this case, the circulation current of the A phase winding still flows in the second lower switch S₄, and a circulation current Isc of the A phase winding flows in the internal diode of the second upper switch S₂ as shown in FIG. 4B.

A voltage Vsc across the second upper switch S₂ is changed into 0 due to the flow of the circulation current through the internal diode.

In this case, a current Ida flowing through the first diode D1 is the same as the current flowing in the second diode D2 as shown in FIG. 4B.

In the next section (section T5 to T6 of FIG. 4B), the second upper switch S₃ is turned on in a state in which the second lower switch S₄ is maintained in the turn-on state.

In this case, a current loop configured of the second upper switch S₃, the B phase winding, and the second lower switch S₄ and a current loop configured of the second upper switch S₃, the first diode D1, the A phase winding, the second diode, and the second lower switch S₄ are overlapped with each other as shown in FIG. 5E.

In this case, a current corresponding to a difference between the current flowing in the B phase winding and the current flowing in the A phase winding flows in the second upper switch S₃ and the second lower switch S₄ (overlapping between an A phase operation mode 3 and a B phase operation mode 1).

In this case, since a voltage across the second upper switch S₃ was changed to 0 due to the flow of the circulation current through the internal diode, the first upper switch is turned in a zero voltage state to minimize switching loss.

In the next section (section T6 to T7 of FIG. 4B), when the second upper switch S₃ and the second lower switch S₄ are continuously maintained in the turn-on state, the current flowing in the A phase winding is slowly decreased, such that only a loop of the current flowing in the second upper switch S₃ and the second lower switch S₄ remains (the B phase operation mode 1).

Then, a process of turning off the second upper switch S₃ in a state in which the second lower switch S₄ is maintained in the turn-on state (a B phase operation mode 2), turning on the first lower switch S₂ in a state in which the second lower switch S₄ is maintained in the turn-on state after a predetermined time (a B phase operation mode 3), and turning on the first upper switch S₁ in a state in which the first lower switch S₂ is maintained in the turn-on state (overlapping between the B phase operation mode 3 and the A phase operation mode 1) and maintaining the first upper switch S₁ in the turn-on state (the A phase operation mode 1) is repeated to drive the SRM.

That is, in the case of using a switching method of the converter circuit according to the preferred embodiment of the present invention, zero voltage switching is possible, such that switching loss may be decreased in a motor requiring high speed rotation. In the zero voltage switching, in the case in which a switch and a diode are formed in a parallel structure, when the diode is turned on to have a voltage close to 0, the switch is turned on, thereby making it possible to decrease loss generated in the switch. In addition, according to the preferred embodiment of the present invention, since the number of diodes may be decreased as compared with an existing switching apparatus for an SRM, a cost, a size, and a torque ripple may be decreased as compared with the existing switching apparatus for an SRM. In order to control driving of the SRM in which the converter circuit performing the operation described above with reference to FIGS. 4 and 5 is implemented, whether or not a current speed has arrived at a target speed, whether or not the zero voltage switching has been performed, and whether or not a negative torque has been generated need to be judged.

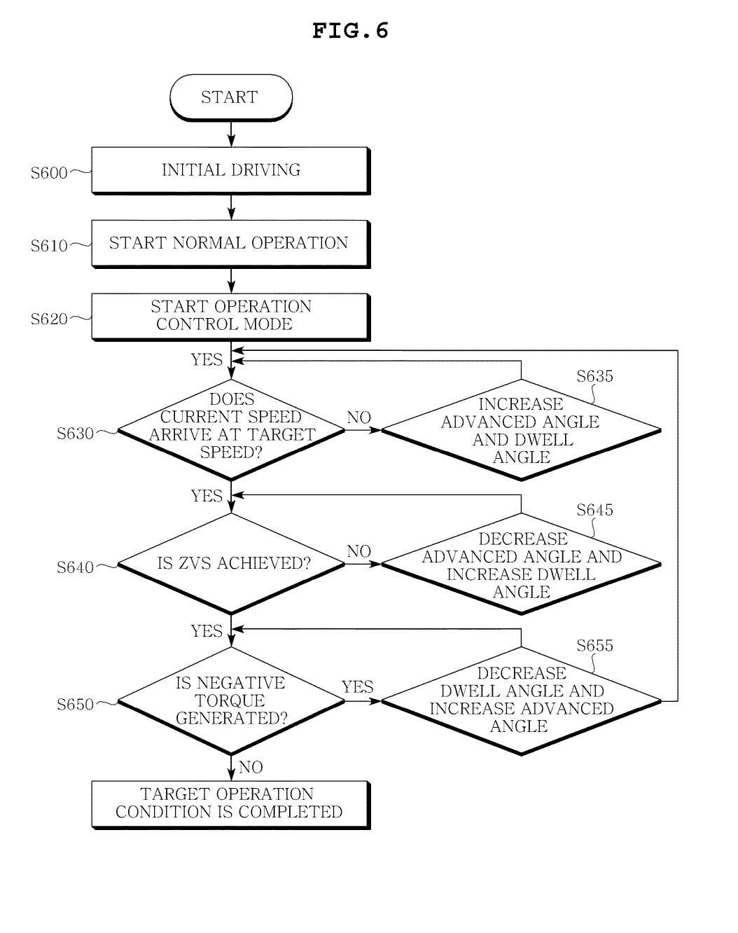

FIG. 6 is a flow chart showing a method of driving the SRM according to the preferred embodiment of the present invention.

Referring to FIG. 6, initial driving is performed (S600).

In step S600, the operation of the first to third sections of FIG. 3 described above may be performed.

In step S600, in order to perform the initial driving of the SRM, only a small amount of power may be allowed to flow the winding of the SRM to move the stator and the rotor of the SRM to a determined position, such that the SRM is set to be in a driving standby state. The dwell angle of the SRM is changed from the initial set dwell angle to the dwell angle set in the normal operation state. That is, a control for the PWM duty ratio, the advanced angle, and the dwell angle is performed in order to perform the initial driving of the SRM, thereby making it possible to change the SRM to be in a normal driving step.

The SRM is normally driven (S610).

A PWM frequency is raised as much as possible, thereby making it possible to drive the SRM at a normal speed. In a normal driving state of the SRM, the SRM may be operated at a set dwell angle and advanced angle.

An operation control mode of the SRM is performed (S620).

The operation control mode indicates an operation mode of comparing a current speed with a target speed to start a command controlling the current speed to be the target speed.

In the operation control mode of the SRM according to the preferred embodiment of the present invention, whether or not the current speed has arrived at the target speed, whether or not the zero voltage switching (ZVS) has been achieved in the case in which the current speed has arrived at the target speed, whether or not the negative torque has been generated in the case in which the current speed has arrived at the target speed and the ZVS has been achieved, and the like, are judged, such that the advanced angle and the dwell angle may be changed.

Whether or not the current speed has arrived at the target speed is judged (S630).

In the case in which it is judged that the current speed has not arrive at the target speed, the advanced angle and the dwell angle are controlled, thereby making it possible to drive the SRM at the target speed.

For example, in the case in which the current speed is more than the target speed, the advanced angle and the dwell angle may be decreased, and in the case in which the current speed is less than the target speed, the advanced angle and the dwell angle may be increased (S635).

In the case in which it is judged that the current speed has arrived at the target speed, whether or not the ZVS has been achieved is judged (S640).

In the case in which it is judged that the current speed has arrived at the target speed, whether or not the ZVS is possible may be judged. In the case in which a current input to the converter is sensed, such that a current having a negative polarity is present, it may be judged that the ZVS is possible. In the case in which the current input to the converter is sensed, such that the current having the negative polarity is not present, it is judged that the ZVS is not possible. In this case, the advanced angle is decreased and the dwell angle is increased, thereby making it possible to control the SRM so that the ZVS state is achieved (S645). For example, the advanced angle is deceased by 1 degree and the dwell angle is increased by 2 degrees, thereby making it possible to control the SRM so that the ZVS state is achieved.

In the case in which the current speed has arrived at the target speed and ZVS state has been achieved, whether or not the negative torque has been generated is judged (S650).

When the current of the diode D1 is sensed, such that a flow of the current is present at phases of 0 degree and 180 degrees, it is judged that the negative torque has been generated. In this case, the advanced angle may be increased and the dwell angle may be decreased (S655). For example, the advanced angle may be increased by 5 degrees and the dwell angle may be decrease by 3 degrees.

When the current of the diode D1 is sensed, such that a flow of the current is not present at the phases of 0 degree and 180 degrees, it is judged that the negative torque has not been generated. In this case, the SRM may be driven without performing an additional control for the advanced angle and the dwell angle.

The control method according to the preferred embodiment of the present invention described above is used, thereby making it possible to obtain an effect such as a noise/vibration decrease, or the like, by a motor rotation speed, the ZVS, and removal of the negative torque.

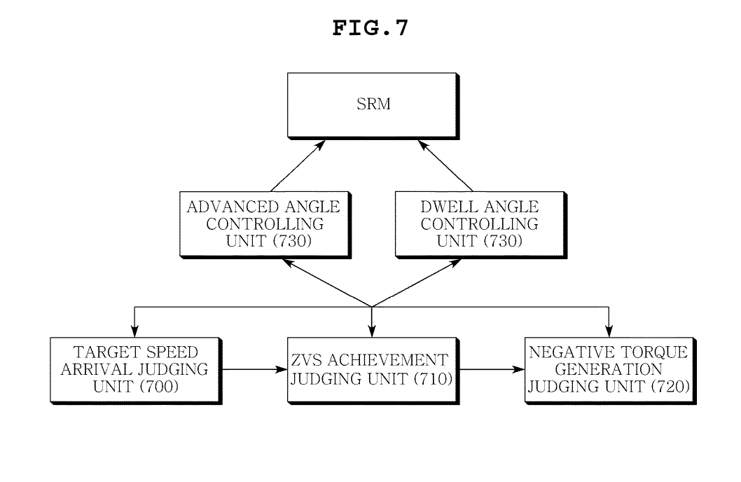

FIG. 7 is a flow chart showing an apparatus of controlling driving of the SRM according to the preferred embodiment of the present invention.

Referring to FIG. 7, the apparatus of controlling driving of the SRM may be configured to include a target speed arrival judging unit 700, a ZVS achievement judging unit 710, a negative torque generation judging unit 720, an advanced angle controlling unit 730, and a dwell angle controlling unit 740.

The target speed arrival judging unit 700 may be implemented so as to judge whether or not a current driving speed of the SRM has arrived at a set target driving speed in driving the SRM. For example, when the SRM is intended to be driven in a 1000 rpm, a target speed of the SRM may be set to 1000 rpm, and it may be judged that the current driving speed has arrived at the corresponding target speed. In the case in which the target speed arrival judging unit judges that the current speed is more than the target speed, it commands the advanced angle controlling unit 730 to decrease the advanced angle and commands the dwell angle controlling unit 740 to decrease the dwell angle, thereby making it possible to perform a control so that the current speed of the SRM is decreased to the target speed. To the contrary, in which the target speed arrival judging unit judges that the current speed is less than the target speed, it commands the advanced angle controlling unit 730 to increase the advanced angle and commands the dwell angle controlling unit 740 to increase the dwell angle, thereby making it possible to perform a control so that the current speed of the SRM is increased to the target speed.

The ZVS achievement judging unit 710 may judge whether or not a zero voltage switching state is present in the SRM. In the case in which the ZVS achievement judging unit judges that the ZVS state is not obtained, it commands the advanced angle controlling unit 730 to decrease the advanced angle and commands the dwell angle controlling unit 740 to increase the dwelled angle, thereby making it possible to control the advanced angle and the dwell angle of the SRM so that the ZVS state is obtained. The ZVS achievement judging unit 710 may judge whether or not the ZVS state has been obtained in the SRM after the target speed arrival judging unit 700 judges that the SRM is driven at the target speed.

The negative torque generation judging unit 720 may judge whether or not the negative torque has been generated in the SRM. In the case in which the negative torque generation judging unit 720 judges that the negative torque has not been generated, it may judge that the SRM is in a target operation state and drive the SRM at a set dwell angle and advanced angle. To the contrary, in the case in which the negative torque generation judging unit 720 judges that the negative torque has been generated, it may command the dwell angle controlling unit 740 to decrease the dwell angle and command the advanced angle controlling unit 730 to increase the advanced angle.

The negative torque generation judging unit 720 may perform the judgment after the ZVS achievement judging unit 710 judges that the ZVS state is present.

The advanced angle controlling unit 730 may control the advanced angle of the SRM according to control signals of the target speed arrival judging unit 700, the ZVS achievement judging unit 710, and the negative torque generation judging unit 720.

The dwell angle controlling unit 740 may control the dwell angle of the SRM according to the control signals of the target speed arrival judging unit 700, the ZVS achievement judging unit 710, and the negative torque generation judging unit 720.

As set forth above, with the method and apparatus of controlling driving of a two-phase SRM according to the preferred embodiments of the present invention, the dwell angle and the advanced angle are controlled based on the judgment results for whether or not the current speed of the SRM has arrived at the target speed, whether or not the ZVS has been achieved, and whether or not the negative torque has been generated, thereby making it possible to decrease the noise and the vibration of the SRM.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus of controlling driving of a switched reluctance motor (SRM), the apparatus comprising:
a target speed arrival judging unit judging whether or not a current speed of the SRM has arrived at a target speed;
a zero volt switching (ZVS) achievement judging unit judging whether or not the SRM is in a state in which ZVS is possible;
a negative torque generation judging unit judging whether or not a negative torque has been generated in the SRM;
an advanced angle controlling unit judging whether or not an advanced angle will be controlled based on judgment results of the target speed arrival judging unit, the ZVS achievement judging unit, and the negative torque generation judging unit; and
a dwell angle controlling unit judging whether or not a dwell angle will be controlled based on the judgment results of the target speed arrival judging unit, the ZVS achievement judging unit, and the negative torque generation judging unit.

2. The apparatus as set forth in claim 1, wherein the target speed arrival judging unit is implemented to change the advanced angle in the advanced angle controlling unit and change the dwell angle in the dwell angle controlling unit in the case in which it judges that the current speed of the SRM has not arrived at the target speed.

3. The apparatus as set forth in claim 2, wherein the target speed arrival judging unit is implemented to decrease the advanced angle and the dwell angle in the case in which it judges that the current speed of the SRM is more than the target speed and increase the advanced angle and the dwell angle in the case in which it judges that the current speed of the SRM is less than the target speed.

4. The apparatus as set forth in claim 2, wherein the ZVS achievement judging unit is implemented to decrease the advanced angle in the advanced angle controlling unit and increase the dwell angle in the dwell angle controlling unit in the case in which it judges that the SRM is in a state in which the ZVS is not possible.

5. The apparatus as set forth in claim 4, wherein the ZVS achievement judging unit is implemented to judge that the SRM is in a state in which the ZVS is possible in the case in which a current input to a converter of the SRM is sensed, such that a current having a negative polarity is present.

6. The apparatus as set forth in claim 2, wherein the negative torque generation judging unit is implemented to judge whether or not the negative torque has been generated in the SRM and increase the advanced angle in the advanced angle controlling unit and decrease the dwell angle in the dwell angle controlling unit in the case in which it judges that the negative torque has been generated in the SRM.

7. The apparatus as set forth in claim 6, wherein the negative torque generation judging unit is implemented to judge that the negative torque has been generated when a current of a diode is sensed, such that a flow of a current is present at phases of 0 degree and 180 degrees.

8. A method of controlling driving of an SRM, the method comprising:
normally driving the SRM after an initial driving section of the SRM; and
controlling a dwell angle and an advanced angle of the SRM by performing an operation control mode of the SRM.

9. The method as set forth in claim 8, wherein the controlling of the dwell angle and the advanced angle of the SRM by performing the operation control mode of the SRM includes:
judging whether or not a current speed of the SRM has arrived at a target speed;
driving the SRM at the target speed by controlling the dwell angle and the advanced angle in the case in which it is judged that the current speed of the SRM has not arrived at the target speed; and
judging whether or not the SRM is in a state in which ZVS is possible in which it is judged that the current speed of the SRM has arrived at the target speed.

10. The method as set forth in claim 9, wherein the driving of the SRM at the target speed by controlling the dwell angle and the advanced angle in the case in which it is judged that the current speed of the SRM has not arrived at the target speed includes:
decreasing the advanced angle and the dwell angle in the case in which it is judged that the current speed of the SRM is more than the target speed; and
increasing the advanced angle and the dwell angle in the case in which it is judged that the current speed of the SRM is less than the target speed.

11. The method as set forth in claim 9, wherein the controlling of the dwell angle and the advanced angle of the SRM by performing the operation control mode of the SRM includes:
judging whether or not the SRM is in the state in which the ZVS is possible; and
controlling the SRM to be in the state in which the ZVS is possible by decreasing the advanced angle and increasing the dwell angle in the case in which it is judged that the SRM is in a state in which the ZVS is not possible.

12. The method as set forth in claim 8, wherein the judging of whether or not the SRM is in the state in which the ZVS is possible includes judging that the SRM is in the state in which the ZVS is possible in the case in which a current input to a converter of the SRM is sensed, such that a current having a negative polarity is present.

13. The method as set forth in claim 9, wherein the controlling of the dwell angle and the advanced angle of the SRM by performing the operation control mode of the SRM includes:
judging whether or not a negative torque has been generated in the SRM; and
increasing the advanced angle and decreasing the dwell angle in the case in which it is judged that the negative torque has been generated in the SRM.

14. The method as set forth in claim 13, wherein the judging of whether or not the negative torque has been generated in the SRM includes judging that the negative torque has been generated when a current of a diode is sensed, such that a flow of a current is present at phases of 0 degree and 180 degrees.

15. The method as set forth in claim 8, wherein the normal driving of the SRM after the initial driving section of the SRM includes:
allowing power to flow in a winding of the SRM to move a stator and a rotor to a determined position, thereby setting the SRM to be in a standby state;
changing an initial set dwell angle of the SRM into a dwell angle in a normal operation state and raising a pulse width modulation (PWM) frequency; and
changing an initial set advanced angle of the SRM into an advanced angle in the normal operation state and raising the PWM frequency.
